(19) United States
(12) Patent Application Publication
(10) Pub. No.: US 2026/0329159 A1
(43) Pub. Date: Oct. 22, 2026

(54) QUICK-RELEASE ASSEMBLY, PHOTOGRAPHIC ACCESSORY, AND ASSEMBLY AND DISASSEMBLY KIT

(71) Applicant: SHENZHEN LEQI INNOVATION CO., LTD., SHENZHEN (CN)

(72) Inventor: QIANG LIN, SHENZHEN (CN)

(21) Appl. No.: 19/529,108

(22) Filed: Feb. 4, 2026

(30) Foreign Application Priority Data
Feb. 21, 2025 (CN) 202510197680.9

(51) Int. Cl. G03B 17/56

(52) U.S. Cl. CPC G03B 17/566

(57) ABSTRACT

A quick-release assembly for a photographic accessory is provided. The quick-release assembly includes: a connection base, two clamping arms movably connected to the connection base and arranged on opposite sides of the connection base, and a locking mechanism disposed on the connection base and configured to act on the two clamping arms. The two clamping arms and the connection base define a mounting slot for mounting a structural component. The quick-release assembly has a locked state and an unlocked state. In the locked state, the two clamping arms are pressed by the locking mechanism, the two clamping arms are closed toward each other and the structural component is clamped by the two clamping arms. In the unlocked state, the two clamping arms are released from the locking mechanism, the two clamping arms are opened away from each other and the structural component is released from the two clamping arms.

### TECHNICAL FIELD

The present disclosure relates to the technical field of photographic equipment, and in particular, to a quick-release assembly, a photographic accessory, and an assembly and disassembly kit.

### BACKGROUND

In the field of photographic equipment, the realization of various functions commonly relies on effective connections between different devices. For instance, in common shooting scenarios, a camera support, serving as a fundamental support device, commonly requires the attachment of various functional accessories, such as fill lights, microphones, etc., to enhance shooting capabilities and meet diverse user needs. In such cases, connecting mechanisms become critical components in linking the camera support with these functional devices.

However, the connecting mechanisms in related art are complex in structure and prone to slipping, leading to insufficient stability between connected devices. During shooting, attached devices may shake or even detach, severely compromising both shooting stability and image quality. This significantly impacts the user experience and fails to meet the demand for reliable and stable performance in photographic equipment.

### SUMMARY

The present disclosure provides a quick-release assembly, aiming to address the issues of insufficient connection stability between devices in photographic equipment.
To realize the above objective, the present disclosure provides a quick-release assembly for a photographic accessory. The quick-release assembly includes:
a connection base;
two clamping arms movably connected to the connection base, where one clamping arm is arranged on a side of the connection base and the other clamping arm is arranged on an opposite side of the connection base, and the two clamping arms and the connection base cooperatively define a mounting slot for mounting a structural component; and
a locking mechanism disposed on the connection base and configured to act on the two clamping arms; where
the quick-release assembly has a locked state and an unlocked state; in the locked state, the two clamping arms are pressed by the locking mechanism, the two clamping arms are closed toward each other and the structural component is clamped by the two clamping arms; and in the unlocked state, the two clamping arms are released from the locking mechanism, the two clamping arms are opened away from each other and the structural component is released from the two clamping arms.

In some embodiments, the two clamping arms are rotatably connected to the connection base, each of the two clamping arms comprises a clamping end configured to clamp the structural member and a pressure-receiving end. The locking mechanism comprises an operation component and a first elastic component. The operation component is movably connected to the connection base, the operation component is configured to switch to a locking position to press against the pressure-receiving ends, to allow the two clamping arms to rotate so as to drive the clamping ends to clamp the structural component; and the operation component is further configured to switch to an unlocking position to release the pressure-receiving ends, to allow the two clamping arms to rotate so as to drive the clamping ends to release the structural component. The first elastic component acts on the operation component, and is configured to provide an elastic force to the operation component to drive the operation component to return to the locking position.

In some embodiments, the operation component includes a rotating member rotatably connected to the connection base, a lever member connected to the rotating member or integrally formed with the rotating member, and a pressing member connected to the rotating member or integrally formed with the rotating member. The lever member extends outward from a circumferential side of the rotating member, and the lever member is configured to drive the rotating member to rotate when subjected to an external force. The pressing member is configured to move along with rotation of the rotating member to press against or release the pressure-receiving ends.

In some embodiments, the connection base includes a first half housing and a second half housing detachably connected to the first half housing. The second half housing and the first half housing enclose an accommodation cavity. The two clamping arms are rotatably connected to the first half housing, the pressure-receiving ends of the two clamping arms are located inside the accommodation cavity, and the clamping ends of the two clamping arms extend outside the accommodation cavity. The rotating member is located inside the accommodation cavity and is rotatably connected to at least one selected from the group consisting of the first half housing and the second half housing. The pressing member is located inside the accommodation cavity. At least one selected from the group consisting of the first half housing and the second half housing is defined with an avoidance opening, and the lever member extends through the avoidance opening to be exposed outside the connection base.

In some embodiments, the first half housing is defined with an accommodation groove extending around a rotation axis of the rotating member. The operation component further includes a connection member extending into the accommodation groove, the connection member is arranged along a circumferential direction of the rotating member and configured to move along with the rotating member. The first elastic component comprises a spring received in the accommodation groove, an end of the spring is connected to a wall at an end of the accommodation groove, and the other end of the spring is connected to the connection member.

In some embodiments, the accommodation groove is one of two accommodation grooves, and the two accommodation grooves are arranged to face each other; the spring is one of two springs, and each of the two springs is received in one of the two accommodation grooves; and the connection member is one of two connection members, wherein one connection member is connected to the rotating member and extends into one accommodation groove to connect with the spring in the one accommodation groove, and the other connection member is connected to the lever member and extends into the other accommodation groove to connect with the spring in the other accommodation groove.

In some embodiments, the rotating member is defined with a shaft hole, a connecting shaft is provided on an inner wall of the second half housing, and the connecting shaft is inserted into the shaft hole to allow the rotating member to be rotatably connected to the second half housing. The connecting shaft is defined with a connection hole which extends in an axial direction of the connecting shaft and penetrates through an outer wall of the second half housing.

In some embodiments, the rotating member is provided with a mounting hole and a limiting member, the mounting hole is located on a circumferential side of a rotation axis of the rotating member, the limiting member is slidably disposed in the mounting hole and is capable of elastically extending from or retracting into the mounting hole. The first half housing is defined with a limiting hole extending through the first half housing, a pushing member is slidably disposed in the limiting hole, and the pushing member is capable of extending from or retracting into an end opening of the limiting hole. The limiting hole is located along a rotation path of the limiting member, and the limiting member is capable of extending from the end opening of the limiting hole into the limiting hole to form a stopping and limiting on the rotating member; and the pushing member is capable of retracting into the limiting hole to push the limiting member out of the limiting hole, to cancel the stopping and limiting on the rotating member.

In some embodiments, each of the two clamping arms is provided with a first magnetic member disposed at the pressure-receiving end of the clamping arm; the connection base is provided with a second magnetic member disposed to face the first magnetic member, the second magnetic member is configured to apply a magnetic attraction force to the first magnetic member, where a direction of the magnetic attraction force is the same as a direction in which the operation component presses against the pressure-receiving end of the clamping arm.

The present disclosure further provides a photographic accessory, which includes an accessory body and the quick-release assembly of any one of the foregoing embodiments. The connection base is connected to the accessory body.

The present disclosure further provides an assembly and disassembly kit, which includes: a structural component and the photographic accessory of any one of the foregoing embodiments. The structural component is connected to the quick-release assembly.

In some embodiments, the connection base is slidable relative to the structural component along a longitudinal direction of the structural component. The structural component is defined with a plurality of positioning grooves spaced apart along the longitudinal direction of the structural component, the connection base is provided with a positioning member, and the positioning member is configured to engage with at least one of the plurality of positioning grooves to position the connection base.

The quick-release assembly provided by the present disclosure can be connected to the structural component to achieve connections between different devices in photographic equipment. For example, in practical applications, two devices (hereinafter referred to as a first device and a second device) in the photographic equipment are connected by coupling the quick-release assembly to the structural component. The first device is connected to the quick-release assembly. The structural component may be the second device to be connected, or an intermediate component connected to the second device. The structural component is fitted in a mounting slot defined by the two clamping arms and the connection base. In the unlocked state, the locking mechanism releases the two clamping arms, allowing them to open away from each other to release the structural component, thereby enabling separation of the structural component from the quick-release assembly. In the locked state, the locking mechanism presses the two clamping arms, causing them to close toward each other to clamp the structural component, thereby establishing a stable connection between the quick-release assembly and the structural component. This ensures a secure connection between the two devices, which prevents shaking or detachment during use of the photographic equipment, maintains shooting stability and image quality, and thereby enhancing user experience and meeting requirements for equipment stability and reliability.

### BRIEF DESCRIPTION OF THE DRAWINGS

FIG. 1 is a schematic diagram of an assembled structure of a quick-release assembly and a structural component according to an embodiment of the present disclosure.

FIG. 2 is a schematic diagram of a disassembled structure of a quick-release assembly and a structural component according to an embodiment of the present disclosure.

FIG. 3 is an exploded view of a quick-release assembly according to an embodiment of the present disclosure.

FIG. 4 is a schematic diagram of an internal structure of a quick-release assembly according to an embodiment of the present disclosure.

FIG. 5 is an exploded view of a quick-release assembly according to another embodiment of the present disclosure.

FIG. 6 is an exploded view of a quick-release assembly according to yet another embodiment of the present disclosure.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

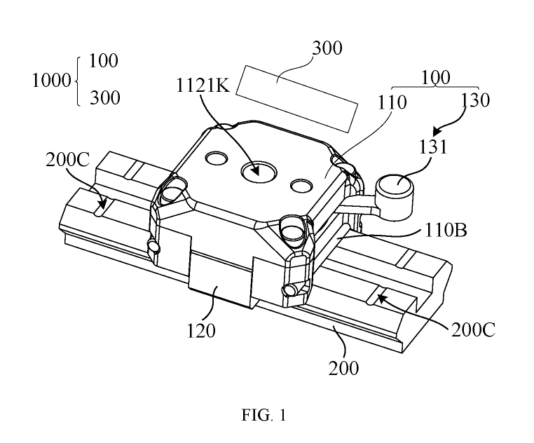

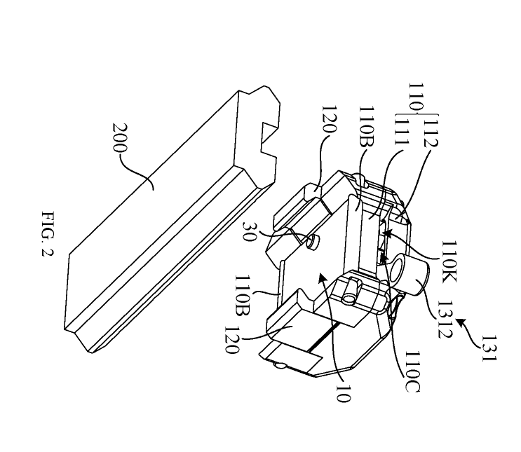

In some embodiments, the present disclosure provides a quick-release assembly 100 for a photographic accessory. Referring to FIGS. 1 and 2, the quick-release assembly 100 includes a connection base 110, two clamping arms 120, and a locking mechanism 130.

The two clamping arms 120 are movably connected to the connection base 110. One clamping arm 120 is arranged on a side of the connection base 110, and the other clamping arm 120 is arranged on an opposite side of the connection base 110. The two clamping arms 120 and the connection base 110 cooperatively define a mounting slot 10 for mounting a structural component 200.

The locking mechanism 130 is disposed on the connection base 110 and is configured to act on the two clamping arms 120.

The quick-release assembly 100 has a locked state and an unlocked state. In the locked state, the two clamping arms 120 are pressed by the locking mechanism 130, the two clamping arms 120 are closed toward each other and the structural component 200 is clamped by the two clamping arms 120. In the unlocked state, the two clamping arms 120 are released from the locking mechanism 130, the two clamping arms 120 are opened away from each other and the structural component 200 is released from the two clamping arms 120.

The quick-release assembly 100 provided herein is applied to photographic equipment, to achieve connection between devices in the photographic equipment. In some embodiments, the quick-release assembly 100 is connected to the structural component 200. In practical application, two devices in the photographic equipment are connected via the coupling of the quick-release assembly 100 and the structural component 200.

In some embodiments, the two devices in the photographic equipment are referred to as a first device and a second device, respectively. The first device is connected to the quick-release assembly 100 by means of screw connection or snap-fit connection. For example, as shown in FIG. 1, the connection base 110 of the quick-release assembly 100 is defined with a connection hole 1121K for connecting the first device. In some embodiments, the first device is a functional device, such as a fill light, a microphone, or the like, including but not limited thereto.

In some embodiments, the structural component 200 is the second device that needs to be connected. That is, the first device is connected to the quick-release assembly 100, and the quick-release assembly 100 is connected to the structural component 200 (i.e., the second device), achieving the connection between the two devices. Alternatively, the structural component 200 serves as an intermediate one connected to the second device by means of screw connection or snap-fit connection. In other words, the first device is connected to the quick-release assembly 100, the second device is connected to the structural component 200, and the quick-release assembly 100 is connected to the structural component 200, thereby achieving the connection between the two devices. The second device is, for example, a photographic support or the like, including but not limited thereto.

In the quick-release assembly 100, the connection base 110 serves as a supporting structure, providing a base for the installation and connection of other parts. The clamping arms 120 are movably connected to the connection base 110 by way of sliding connection, rotational connection, or the like, and can move within a certain range. The clamping arms 120 movably connecting to the connection base 110 allows the clamping arms 120 to move relative to the connection base 110 as required to perform opening or closing, so as to clamp various structural components 200 with different sizes. For example, the clamping arms 120 are rotatably connected to the connection base 110, thus the clamping arms 120 can pivot about the connection points to perform opening and closing movements.

The locking mechanism 130 is a key component and configured to switch the quick-release assembly 100 between the locked state and the unlocked state. The locking mechanism 130 controls the motion of the two clamping arms 120 by applying or releasing mechanical force. When the locking mechanism 130 applies force, the two clamping arms 120 are forced to close toward each other, securing the structural component 200 within the mounting slot 10 through friction and clamping force. When the force from the locking mechanism 130 is released, the two clamping arms 120 open away from each other under their own elastic restoring forces or a slight external force, thereby releasing the structural component 200.

In some embodiments, the locking mechanism 130 includes internal mechanical transmission structures, such as a cam mechanism or a lever mechanism. In a configuration that a cam mechanism is employed, the rotation of the cam can change the position of its profile in contact with the clamping arms 120, thereby driving the movement of the clamping arms 120. In a configuration that a lever mechanism is employed, force applied to one end of the lever is amplified and transferred to the clamping arms 120, effecting the movement of the clamping arms 120. The above descriptions are illustrative rather than restrictive, beyond these, the locking mechanism 130 may also employ other structures.

When the locking mechanism 130 applies an external force, the two clamping arms 120 rotate toward each other about their articulated connection points with the connection base 110 in accordance with mechanical principles. When the clamping arms 120 come into contact with the structural component 200, the clamping arms 120 exert a normal force on the surface of the structural component 200 based on the principles of friction, thereby generating a frictional force. Simultaneously, the closing motion of the clamping arms 120 produces a clamping force on the surface of the structural component 200. These two forces work together to securely fix the structural component 200 positioned within the mounting slot 10. When the locking mechanism 130 releases the external force, the clamping arms 120, driven either by their own elastic restoring force (in the configuration that the clamping arms 120 are made of a material with certain elasticity) or by a slight external force (such as a user gently pulling the clamping arms 120 apart), once again rotate away from each other about their articulated connection points with the connection base 110, in accordance with mechanical principles, thereby releasing the structural component 200.

The specific operational process is described as follows.

### Locking Process

The to-be-connected photographic device is mounted onto the structural component 200 through the mounting slot 10 of the quick-release assembly 100. Then, the locking mechanism 130 is operated to press the two clamping arms 120, allowing the two clamping arms 120 to gradually close toward each other under the pressure from the locking mechanism 130. The space within the mounting slot 10 is progressively reduced along with the closing motion of the two clamping arms 120, until the two clamping arms 120 come into tight contact with the structural component 200. The structural component 200 is thereby securely clamped through frictional force and clamping force, completing the locked connection between the quick-release assembly 100 and the structural component 200.

### Unlocking Process

To detach the photographic device, the locking mechanism 130 is operated in reverse to release its pressure on the two clamping arms 120. The two clamping arms 120 open away from each other either due to their own degrees of freedom of movement or under a slight external force (e.g., a user gently pulling the clamping arms 120 apart). As the two clamping arms 120 open away from each other, the space within the mounting slot 10 gradually increases, causing the clamping force between the quick-release assembly 100 and the structural component 200 to disappear. As such, the quick-release assembly 100 can be easily separated from the structural component 200, completing the unlocking process.

To meet the requirement for secure connection between components in photographic equipment, the quick-release assembly 100 employs the coordinated operation of the connection base 110, the clamping arms 120, and the locking mechanism 130 to achieve stable clamping and rapid attachment/detachment of the structural component 200. By applying or releasing pressure on the two clamping arms 120, the locking mechanism 130 controls the clamping force exerted on the structural component 200, thereby enabling the switching of the quick-release assembly 100 between the locked state and the unlocked state.

The quick-release assembly 100 provided herein enables a secure connection between devices in the photographic equipment, effectively preventing shaking or detachment of the devices during use of the photographic equipment. This ensures stability during shooting and maintains image quality, thereby enhancing the user experience and meeting user’s requirements for the stability and reliability of the photographic equipment.

In some embodiments, with reference to FIGS. 2 to 4, the two clamping arms 120 are rotatably connected to the connection base 110. Each clamping arm 120 has a clamping end 121 configured to clamp the structural component 200 and a pressure-receiving end 122.

The locking mechanism 130 includes an operation component 131 and a first elastic component 132.

The operation component 131 is movably connected to the connection base 110. The operation component 131 is configured to switch between a locking position and an unlocking position. In the locking position, the operation component 131 presses against the pressure-receiving ends 122, allowing the clamping arms 120 to rotate and thereby driving the clamping ends 121 to clamp the structural component 200. In the unlocking position, the operation component 131 releases the pressure-receiving ends 122, allowing the clamping arms 120 to rotate and thereby driving the clamping ends 121 to release the structural component 200.

The first elastic component 132 is configured to act on the operation component 131. The first elastic component 132 provides an elastic force to the operation component 131, to drive the operation component 131 to return to the locking position.

In the embodiments, the two clamping arms 120 are both rotatably connected to the connection base 110. This provides the basis for the flexible opening and closing actions of the clamping arms 120. One end of each clamping arm 120 is configured as the clamping end 121 for clamping the structural component 200, and the other end of each clamping arm 120 serves as the pressure-receiving end 122. In some embodiments, the clamping end 121 is substantially hook-shaped. This functional division of the two ends enables the clamping arms 120 to efficiently clamp and release the structural component 200 during the operation of the quick-release assembly 100. The locking mechanism 130, as the core control part of the quick-release assembly 100, features a structure primarily including the operation component 131 and the first elastic component 132. The operation component 131 is movably connected to the connection base 110 by means of rotational connection or sliding connection, which is not limited thereto. This movable connection allows the operation component 131 to switch its position on the connection base 110. For example, the operation component 131 is operated to switch to the locking position, where it presses against and applies a pressing force on the pressure-receiving ends 122 of the clamping arms 120. The operation component 131 can also be operated to switch to the unlocking position, where it releases the pressure-receiving ends 122 of the clamping arms 120, thereby canceling the pressing force. The first elastic component 132 plays a crucial role in the locking mechanism 130. The first elastic component 132 is configured to act on the operation component 131. The first elastic component 132 provides an elastic force that drives the operation component 131 to return to the locking position. Moreover, the presence of this elastic force ensures that the operation component 131 remains automatically in the locking position without external intervention, thereby maintaining a stable clamping of the structural component 200 by the clamping arms 120. In some embodiments, the first elastic component 132 is a tension spring, a compression spring, a coil spring, or the like, which can be selected according to actual requirements.

To connect and lock the quick-release assembly 100 with the structural component 200, the structural component 200 is first placed into the mounting slot 10 formed between the two clamping arms 120 and the connection base 110. Subsequently, the operation component 131 is subjected to a force (such as the elastic force from the first elastic component 132), allowing it to move from its initial position to the locking position. As the operation component 131 moves to the locking position, it contacts and applies a pressing force to the pressure-receiving end 122 of each clamping arm 120. According to the lever principle, the clamping arm 120 uses its pivot point with the connection base 110 as a fulcrum. When the pressure-receiving end 122 is subjected to compressive force, one of the clamping end 121 rotates toward the other clamping end 121. During this process, the clamping ends 121 of the clamping arms 120 gradually approach each other until they securely clamp the structural component 200. Meanwhile, during the movement of the operation component 131 toward the locking position, the first elastic component 132 undergoes elastic deformation and releases its elastic potential energy. When the unlocking actuator 131 reaches the locking position, the first elastic component 132 continuously applies an elastic force directed toward the locking position to the operation component 131. This ensures that the operation component 131 maintains pressure on the pressure-receiving ends 122 of the clamping arms 120, thereby sustaining a stable clamping state of the clamping arms 120 on the structural component 200.

To detach the quick-release assembly 100 from the structural component 200, i.e., to release the structural component 200 from the clamping arms 120, an external force may be applied to the operation component 131 in the direction opposite to that of in the locking process. This allows the operation component 131 to overcome the elastic force of the first elastic component 132 and move from the locking position to the unlocking position. As the operation component 131 moves, the pressing force applied to the pressure-receiving ends 122 of the clamping arms 120 gradually decreases until it disappears. At this point, under the action of its own gravity (if sufficient to overcome rotational resistance) or any other external force, each clamping arm 120 rotates about its pivot point (fulcrum) with the connection base 110, allowing the clamping end 121 to rotate away from the fulcrum to gradually release the structural component 200. During this process, the first elastic component 132 undergoes elastic deformation and accumulates elastic potential energy.

Through the cooperative interaction of the operation component 131 and the first elastic component 132, the locking mechanism 130, when in the locked state, can continuously and stably apply pressing force to the pressure-receiving ends 122 of the clamping arms 120, ensuring the clamping arms 120 to firmly clamp the structural component 200. This allows for a more stable connection between devices of photographic equipment during use. Further, the operation component 131 allows users to switch the quick-release assembly 100 between the locked state and the unlocked state through simple operations such as toggling or pressing. The self-reset function of the first elastic component 132 reduces additional steps during operation. Thus, there is no need for users to manually operate the operation component 131 to return to the locking position, making the operation smoother and more efficient.

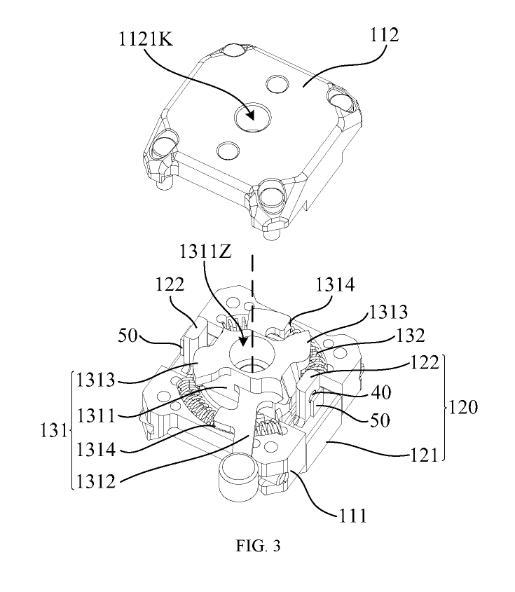

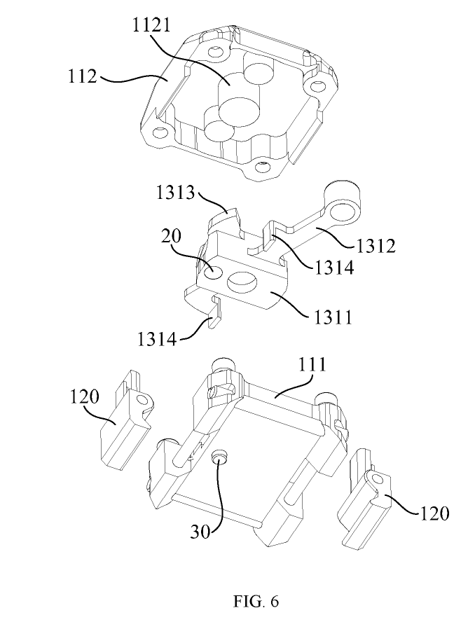

In some embodiments, with reference to FIGS. 3 and 6, the operation component 131 includes a rotating member 1311, a lever member 1312, and a pressing member 1313.

The rotating member 1311 is rotatably connected to the connection base 110.

The lever member 1312 is connected to the rotating member 1311 or integrally formed with the rotating member 1311. The lever member 1312 extends outward from a circumferential side of the rotating member 1311. The lever member 1312 is configured to drive the rotating member 1311 to rotate when subjected to an external force.

The pressing member 1313 is connected to the rotating member 1311 or integrally formed with the rotating member 1311. The pressing member 1313 is configured to switch positions along with rotation of the rotating member 1311 to press against or release the pressure-receiving ends 122.

The rotating member 1311, as the core rotational part of the operation component 131, is rotatably connected to the connection base 110 through rotational joints, such as common pin-shaft connection or bearing connection. This ensures that the rotating member 1311 can rotate smoothly and stably relative to the connection base 110. The rotating member 1311 provides the rotational foundation for the operation of the entire operation component 131, enabling other parts to perform corresponding functions by following its rotation. In some embodiments, the rotating member 1311 is located between the pressure-receiving ends 122 of the two clamping arms 120.

The lever member 1312 is closely associated with the rotating member 1311. The lever member 1312 is connected to the rotating member 1311 or integrally formed with the rotating member 1311. The lever member 1312 extends outward from the circumferential side of the rotating member 1311. This allows users to easily drive the rotation of the rotating member 1311 by applying an external force directly to the lever member 1312. The length and shape of the lever member 1312 are designed according to practical needs. For instance, to facilitate holding and operation, the lever member 1312 is configured as an elongated body with an anti-slip surface.

The pressing member 1313 is connected to the rotating member 1311 or integrally formed with the rotating member 1311. The pressing member 1313 can switch its position with rotation of the rotating member 1311, thereby pressing against or releasing the pressure-receiving ends 122 of the clamping arms 120. The shape and size of the pressing member 1313 are designed according to the structure of the pressure-receiving ends 122 of the clamping arms 120 and the magnitude of the required clamping force. For example, the pressing member 1313 may be a protrusion extending outward from the circumferential side of the rotating member 1311.

In some embodiments, based on the above structures of the operation component 131, the first elastic component 132 may a coil spring. The coil spring is coaxially arranged with the rotating member 1311 and connected to the rotating member 1311. The coil spring is configured to directly provide an elastic force to make the rotating member 1311 to return its initial position. In some other embodiments, the first elastic component 132 may employ other forms and arrangements, which will be explained in subsequent embodiments.

When unlocking is required, user may apply an external force to the lever member 1312. The lever member 1312 drives the rotating member 1311 to rotate toward the unlocking position. As the rotating member 1311 rotates, the pressing member 1313 connected to the rotating member 1311 rotates synchronously. During this rotation, the pressing member 1313 gradually disengages from the pressure-receiving ends 122 of the clamping arms 120, and the pressing force applied to the pressure-receiving ends 122 gradually decreases until it disappears. Consequently, the structural component 200 gradually release from the clamping arms 120, achieving unlocking.

When locking is required, user may release the lever member 1312. Under the elastic force of the first elastic component 132, the rotating member 1311 rotates toward the locking position. As the rotating member 1311 rotates, the pressing member 1313 gradually approaches the pressure-receiving ends 122 of the clamping arms 120. When the rotating member 1311 rotates to a specific angle, i.e., reaches the locking position, the pressing member 1313 contacts the pressure-receiving ends 122 of the clamping arms 120 and applies a pressing force, allowing the clamping arms 120 to clamp the structural component 200.

The overall structure of the operation component 131 is compact and rational. The connection among the rotating member 1311, the lever member 1312, and the pressing member 1313 is simple yet effective, reducing unnecessary parts and complex connecting structures. Moreover, the coordinated working mechanism of the rotating member 1311, the lever member 1312, and the pressing member 1313 ensures that, in the locked state, the pressing member 1313 can stably and accurately apply a clamping force to the pressure-receiving ends 122 of the clamping arms 120.

In some embodiments, with reference to FIGS. 2 and 3, the connection base 110 includes a first half housing 111 and a second half housing 112 detachably connected to the first half housing 111. The second half housing 112 and the first half housing 111 cooperatively enclose an accommodation cavity 110C. The two clamping arms 120 are rotatably connected to the first half housing 111. The pressure-receiving ends 122 of the clamping arms 120 are located inside the accommodation cavity 110C, and the clamping ends 121 of the clamping arms 120 extend outside the accommodation cavity 110C.

The rotating member 1311 is located inside the accommodation cavity 110C and is rotatably connected to at least one selected from the group consisting of the first half housing 111 and the second half housing 112. The pressing member 1313 is also located inside the accommodation cavity 110C. At least one selected from the group consisting of the first half housing 111 and the second half housing 112 is defined with an avoidance opening 110K, through which the lever member 1312 extends to be exposed outside the connection base 110.

The connection base 110 includes the first half housing 111 and the second half housing 112, the two of which are detachably connected by means of snap-fit connection, bolt connection, or magnetic connection. In some embodiments, the first half housing 111 and the second half housing 112 are connected by means of snap-fit connection. The first half housing 111 is provided with an inwardly protruded snap-fit structure along its edge, and the second half housing 112 is provided with a corresponding snap-fit groove for receiving the snap-fit structure. A secure connection is achieved by engaging the snap-fit structure into the snap-fit groove. When disassembly, an appropriate external force is required to disengage the snap-fit structure from the snap-fit groove. This detachable connection facilitates assembly and adjustment in manufacturing process. Further, the connection base 110 can be easily opened for inspection, maintenance, or replacement of internal parts in later servicing process. It should be noted that the foregoing is merely exemplary and not limiting. Other detachable connection approaches, such as screw connection, can also be employed.

The connection of first half housing 111 and the second half housing 112 forms the enclosed accommodation cavity 110C. The size and shape of the accommodation cavity 110C are reasonably to accommodate the installation and operation of internal parts. For instance, the length, width, and height of the accommodation cavity 110C are designed according to the dimensions of the pressure-receiving ends 122 of the clamping arms 120, the rotating member 1311, and the pressing member 1313, ensuring that each part has sufficient clearance for movement inside the accommodation cavity 110C without excessive looseness. The accommodation cavity 110C not only provides physical protection for the internal parts against external impacts, dust, or moisture, but also serves positioning and supporting functions, maintaining their relative positional accuracy during operation.

Each clamping arm 120 is rotationally connected to the first half housing 111. In some embodiments, a mounting shaft is provided on the first half housing 111, and a corresponding mounting hole is defined in the clamping arm 120. The clamping arm 120 is fitted on the mounting shaft through the mounting hole, thereby forming a rotational pair. A high-precision clearance fit is adopted between the mounting shaft and the mounting hole, ensuring smooth rotation of the clamping arm 120 while effectively minimizing wobble during its rotation. The pressure-receiving end 122 of the clamping arm 120 is located within the accommodation cavity 110C, allowing the pressure-receiving end 122 to directly receive the force from the locking mechanism 130. The clamping end 121 of the clamping arm 120 extends outside the accommodation cavity 110C, facilitating the clamping arm 120 to clamp the structural component 200.

The rotating member 1311, serving as the core rotating part of the operation component 131, is installed within the accommodation cavity 110C and is rotatably connected to at least one selected from the group consisting of the first half housing 111 and the second half housing 112. In a configuration that the rotating member 1311 is rotatably connected to the first half housing 111, a support shaft is provided on the first half housing 111, and the rotating member 1311 is fitted on the support shaft to achieve rotational engagement with the first half housing 111. In a configuration that the rotating member 1311 is rotatably connected to the second half housing 112, a connection shaft is provided on the second half housing 112, and the rotating member 1311 is fitted on the connection shaft to achieve rotational engagement with the second half housing 112.

At least one selected from the group consisting of the first half housing 111 and the second half housing 112 is defined with the avoidance opening 110K. The size of the avoidance opening 110K is larger than the cross-sectional dimension of the lever member 1312, and the avoidance opening 110K is arranged to extend along the movement path of the lever member 1312, to ensure the lever member 1312 to move freely through the avoidance opening 110K. In a configuration that the avoidance opening 110K is defined in the first half housing 111, the avoidance opening 110K is located at the edge of the first half housing 111 where it interfaces with the second half housing 112, allowing the lever member 1312 to extend therethrough. In a configuration that the avoidance opening 110K is defined in the second half housing 112, the avoidance opening 110K is located at the edge of the second half housing 112 where it interfaces with the first half housing 111, allowing the lever member 1312 to extend therethrough. In a configuration that each of the first half housing 111 and the second half housing 112 is defined with the avoidance openings 110K, when the first half housing 111 and the second half housing 112 are connected, the avoidance openings 110K cooperatively define a clearance opening through which the lever member 1312 extends. The lever member 1312 extends out through the avoidance opening 110K to be exposed outside the connection base 110 for direct user access. By operating the lever member 1312, a user can easily drive the rotation of the rotating member 1311, which in turns controls the action of the pressing member 1313.

In the embodiments, the two-half-housing configuration of the connection base 110 and the rational layout of parts inside the accommodation cavity 110C contribute to a more compact overall structure for the quick-release assembly 100.

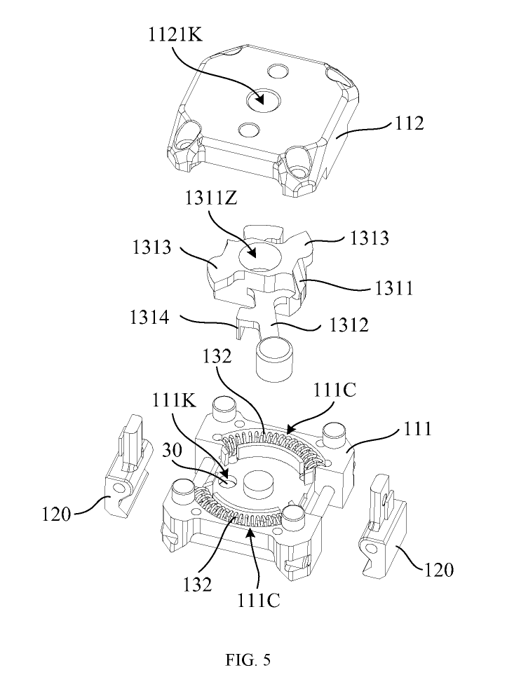

In some embodiments, with reference to FIGS. 5 and 6, the first half housing 111 is defined with an accommodation groove 111C, which extends around the rotation axis of the rotating member 1311.

The operation component 131 further includes a connection member 1314 that extends into the accommodation groove 111C. The connection member 1314 is located on the circumference of the rotating member 1311 and is configured to move along with the rotating member 1311. In some embodiments, the connection member 1314 is directly connected to the rotating member 1311. In some other embodiments, the connection member 1314 is connected to the rotating member 1311 via the lever member 1312. When the rotating member 1311 rotates, the rotating member 1311 drives the connection member 1314 to rotate accordingly.

The first elastic component 132 includes a spring, which is received in the accommodation groove 111C. The spring includes one end connected to a wall at one end of the accommodation groove 111C, and the other end connected to the connection member 1314.

In some embodiments, the spring is a tension spring. When unlocking is required, user may apply an external force to the lever member 1312, such that the lever member 1312 drives the rotating member 1311 to rotate in a first direction about the rotation axis of the rotating member 1311 until the pressing member 1313 disengages from the pressure-receiving ends 122 of the clamping arms 120. Simultaneously, the connection member 1314 follows the rotation of the rotating member 1311, moving within the accommodation groove 111C along the first direction. This elongates the tension spring located within the accommodation groove 111C, allowing the spring to accumulate elastic potential energy.

When locking is required, user may release the lever member 1312. The tension spring releases its stored elastic potential energy, and under the elastic force of the tension spring, the connection member 1314 moves within the accommodation groove 111C along a second direction opposite to the first direction. This drives the rotating member 1311 to rotate about its rotation axis along the second direction until the pressing member 1313 contacts and presses against the pressure-receiving ends 122 of the clamping arms 120.

In some other embodiments, the spring is a compression spring. The type of the spring is selected according to actual requirements, which is not limited herein.

In the embodiments, the arrangement of the accommodation groove 111C extending around the rotation axis of the rotating member 1311, in combined with the connection between the connection member 1314 and the spring, the rotating member 1311, and/or the lever member 1312, allows for a more compact structure of the entire quick-release assembly 100. Moreover, by arranging the spring and the connection member 1314 within the accommodation groove 111C, the internal space of the first half housing 111 is fully utilized. This efficient use of space not only enhances the compactness of the structure but also reduces the risk of mutual interference among components, resulting in a more rational internal layout of the entire quick-release assembly 100. This facilitates manufacturing of the quick-release assembly 100, installation and debugging, as well as subsequent maintenance and repair.

In some embodiments, with reference to FIGS. 5 and 6, two accommodation grooves 111C are provided, which are arranged to face each other.

Correspondingly, two springs are provided, each received in one of the accommodation grooves 111C.

Two connection members 1314 are also provided. One of the connection members 1314 is connected to the rotating member 1311 and extends into one of the accommodation grooves 111C to connect with the spring disposed in the accommodation groove 111C, and the other connection member 1314 is connected to the lever member 1312 and extends into the other accommodation groove 111C to connect with the spring disposed in the other accommodation groove 111C.

In the embodiments, by providing two opposing accommodation grooves 111C, two springs, and two connection members 1314, precise bidirectional control over the reset process of the rotating member 1311 and the lever member 1312 is achieved. The two springs can accurately push the rotating member 1311 and the lever member 1312 back to their initial positions from two opposite directions. Compared to a single-spring configuration, this improves the accuracy and consistency of the reset process. Moreover, during long-term use, even if one of the springs experiences a certain degree of performance degradation, the normal operation of the other spring can still ensure the basic reset function. This redundant design enhances the fault tolerance and service life of the quick-release assembly 100, reducing maintenance and replacement costs caused by component failure.

In some embodiments, with reference to FIGS. 5 and 6, the rotating member 1311 is defined with a shaft hole 1311Z, and a connection shaft 1121 is provided on the inner wall of the second half housing 112. The connection shaft 1121 is inserted into the shaft hole 1311Z so that the rotating member 1311 is rotatably connected to the second half housing 112.

The connection shaft 1121 is defined with the connection hole 1121K, which extends in the axial direction of the connection shaft 1121 and penetrates through the outer wall of the second half housing 112.

In the embodiments, to achieve rotatable connection with the second half housing 112, the rotating member 1311 is defined with the shaft hole 1311Z. In some embodiments, the shape of the shaft hole 1311Z is circular so as to match the corresponding connection shaft 1121. A stable rotational connection between the rotating member 1311 and the second half housing 112 is achieved by the rotational engagement of the shaft hole 1311Z with the connection shaft 1121 of the second half housing 112. The second half housing 112 is defined with the connection hole 1121K at the location of the connection shaft 1121. The connection hole 1121K is configured for mounting an external photographic device, such as an accessory body. In some embodiments, the connection hole 1121K is a threaded hole, which is not limited herein. By arranging the connection hole 1121K in the connection shaft 1121 , no additional space is occupied, resulting in a compact structure. Moreover, the configuration of the connection hole 1121K also extends the functionality of the quick-release assembly 100.

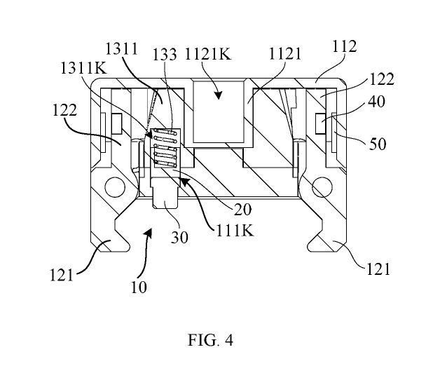

In some embodiments, with reference to FIGS. 4-6, the rotating member 1311 is further provided with a mounting hole 1311K and a limiting member 20. The mounting hole 1311K is located on the circumferential side of the rotation axis of the rotating member 1311. The limiting member 20 is slidably disposed in the mounting hole 1311K and is capable of elastically extending from or retracting into the mounting hole 1311K.

A limiting hole 111K is defined through the first half housing 111. A pushing member 30 is slidably provided in the limiting hole 111K and is capable of extending from or retracting into an opening of the limiting hole 111K.

The limiting hole 111K lies on the rotation path of the limiting member 20. The limiting member 20 is capable of extending into the limiting hole 111K from an opening of the limiting hole 111K for stopping and limiting the rotating member 1311. The pushing member 30 is capable of retracting into the limiting hole 111K to push the limiting member 20 out of the limiting hole 111K, thereby releasing the stopping and limiting on the rotating member 1311.

In the embodiments, through the engagement of the limiting member 20 in the limiting hole 111K of the first housing half 111, the rotating member 1311 achieves precise positioning at a specific angle. As shown in FIG. 4, a second elastic component 133 is provided within the limiting hole 111K. The second elastic component 133 includes an end connected or abutting against the inner wall of the mounting hole 1311K, and the other end connected or abutting against the limiting member 20. The second elastic component 133 is configured to provide an elastic force to the limiting member 20, to drive the limiting member 20 to extend outward from the mounting hole 1311K for resetting. In some embodiments, the limiting member 20 is defined with a recessed hole, and the second elastic component 133 extends into the recessed hole and abuts against the bottom wall of the recessed hole, thereby achieving abutment with the limiting member 20. In some embodiments, the second elastic component 133 is a compression spring.

### Stopping and Limiting Process

Initial State: When the rotating member 1311 is in a free-rotating state, the limiting member 20, under the action of an elastic component (such as the second elastic component 133), protrudes from the mounting hole 1311K beyond the surface of the rotating member 1311 to abut against the inner wall of the first half housing 111, and waits to enter the limiting hole 111K to achieve limiting.

Rotation and Limiting Trigger: When the rotating member 1311 begins to rotate, the limiting member 20 gradually approaches the limiting hole 111K as the rotation proceeds. When the rotating member 1311 rotates to a specific angle, the head of the limiting member 20 aligns with the limiting hole 111K. Under the action of the elastic component (such as the second elastic component 133), the limiting member 20 smoothly inserts into the limiting hole 111K. Due to the high-precision fit between the limiting member 20 and the limiting hole 111K, the insertion of the limiting member 20 realizes a stopping and limiting on the rotating member 1311, preventing further rotation of the rotating member 1311 and ensuring that the rotating member 1311 remains at the predetermined position.

Stable Limiting State: In the limiting state, the limiting member 20 closely fits in the limiting hole 111K, and the second elastic component continuously applies an elastic force to the limiting member 20, ensuring that the limiting member 20 is firmly retained within the limiting hole 111K.

### Releasing the Stopping and Limiting Process

Operation Trigger: When it is necessary to cancel the stopping and limiting on the rotating member 1311, an external force is applied to the pushing member 30. As the external force is applied, the pushing member 30 retracts into the limiting hole 111K and moves toward the limiting member 20. When the pushing member 30 contacts the limiting member 20, a continued application of the external force causes the pushing member 30 to push the limiting member 20 out of the limiting hole 111K.

Restoration of Free Rotation: After the limiting member 20 is pushed out of the limiting hole 111K, it correspondingly retracts into the mounting hole 1311K. At this point, the rotating member 1311 is released from the limiting restraint and returns to a free state, allowing it to be further operated for subsequent movements.

In some embodiments, the wall of the limiting hole 111K is formed with a limiting step, which is configured to limit the pushing member 30 and thereby preventing the pushing member 30 from sliding out of the limiting hole 111K.

The specific angle at which the rotating member 1311 is positioned corresponds to the angle when the quick-release assembly 100 is in the unlocked state. That is, when the limiting member 20 is inserted into the limiting hole 111K to form a limiting engagement, the position of the rotating member 1311 relative to the connection base 110 is fixed and non-rotatable, thereby maintaining the quick-release assembly 100 in the unlocked state. When the pushing member 30 pushes the limiting member 20 out of the limiting hole 111K to cancel the limiting engagement, allowing the rotating member 1311 to rotate relative to the connection base 110, the quick-release assembly 100 can be then switched from the unlocked state to other states, such as the locked state.

In practical application, through the limiting engagement between the limiting member 20 and the limiting hole 111K, the quick-release assembly 100 remains in the unlocked state. Correspondingly, the operation component 131 does not press against the two clamping arms 120, and thus the two clamping arms 120 remain in a relaxed state. Therefore, in some embodiments, when assembling the quick-release assembly 100 with the structural component 200, the quick-release assembly 100 can be pressed directly toward the structural component 200. The structural component 200 can easily push apart the two clamping arms 120 and be installed into the mounting slot 10. Moreover, after the structural component 200 is properly installed in the mounting slot 10, the structural component 200 presses against the pushing member 30, allowing the pushing member 30 to retract into the limiting hole 111K. The pushing member 30 then pushes the limiting member 20 out of the limiting hole 111K, thereby releasing the stopping and limiting on the rotating member 1311. Once the stopping and limiting on the rotating member 1311 is released, under the elastic force of the first elastic component 132, the rotating member 1311 rotates toward the locking position, allowing the pressing member 1313 to press against the pressure-receiving ends 122 of the clamping arms 120. The clamping arms 120 then clamp the structural component 200, and the quick-release assembly 100 automatically switches from the unlocked state to the locked state. This operation is simple, convenient, and effortless.

In some embodiments, once the quick-release assembly 100 is separated from the structural component 200, user can manually operate the lever member 1312 to cause the rotation of the rotating member 1311, so that the limiting member 20 is inserted into the limiting hole 111K to form a limiting engagement. This switches the quick-release assembly 100 to the unlocked state in advance, facilitating the next assembly operation.

In some embodiments, with reference to FIGS. 3 and 4, the clamping arm 120 is provided with a first magnetic member 40 located at the pressure-receiving end 122 of the clamping arm 120.

The connection base 110 is provided with a second magnetic member 50 arranged to face the first magnetic member 40. The second magnetic member 50 is configured to apply a magnetic attraction force to the first magnetic member 40. The direction of the second magnetic member 50 applying the magnetic attraction force to the first magnetic member 40 is the same as the direction in which the operation component 131 presses the pressure-receiving ends 122.

In the embodiments, one of the first magnetic member 40 and the second magnetic member 50 is a magnet block, and the other of the first magnetic member 40 and the second magnetic member 50 is a metal block that is magnetically attracted by the magnet block. Alternatively, both the first magnetic member 40 and the second magnetic member 50 are magnet blocks. This depends on practical requirements. In some embodiments, a recess employed to receive the first magnetic member 40 is defined in the pressure-receiving end 122 of the clamping arm 120, and the first magnetic member 40 is received within this recess. The direction of the magnetic attraction force applied to the first magnetic member 40 by the second magnetic member 50 is the same as that of the pressing force applied to the pressure-receiving end 122 by the operation component 131.

The first magnetic member 40 and the second magnetic member 50 works in coordination and synergy with the operation component 131. The combined effect of the magnetic attraction force and the pressing force applied by the operation component 131 is fully considered in design. Through mechanical analysis and simulation, the magnitude and direction of the magnetic attraction force are determined to synergize with the pressing force applied by the operation component 131 to the pressure-receiving ends 122 of the clamping arms 120, thereby jointly enhancing the clamping force of the clamping arms 120. For example, in the locked state, both the pressing force from the operation component 131 and the magnetic attraction force from the magnetic members act simultaneously on the pressure-receiving ends 122 of the clamping arms 120, enabling the clamping arms 120 to clamp the structural component 200 more tightly and thereby improving connection stability.

The present disclosure further provides a photographic accessory 1000 including an accessory body 300 and the quick-release assembly 100 as described in any of the foregoing embodiments. The connection base 110 of the quick-release assembly 100 is connected to the accessory body 300. The structure of the quick-release assembly 100 refers to the foregoing embodiments. Since this photographic accessory 1000 adopts all the technical solutions of all the foregoing embodiments, it at least possesses all the technical effects brought about by the technical solutions of the foregoing embodiments, which is not detailed herein. The connection between the connection base 110 and the accessory body 300 is fixed, movable, or detachable, etc. The detachable connection is a threaded connection, snap-fit connection, magnetic connection, etc., including but not limited thereto. The accessory body 300 corresponds to the first device mentioned in the foregoing embodiments. In some embodiments, the accessory body 300 is a functional device such as a fill light, microphone, etc., including but not limited thereto.

The present disclosure further provides an assembly and disassembly kit including a structural component 200 and the photographic accessory 1000 as described in the foregoing embodiments. The structure of the photographic accessory 1000 refers to the foregoing embodiments. Since the assembly and disassembly kit adopts all the technical solutions of all the foregoing embodiments, it at least possesses all the technical effects brought about by the technical solutions of the foregoing embodiments, which is not detailed herein.

In some embodiments, with reference to FIGS. 1 and 2, the connection base 110 is slidable relative to the structural component 200 along a longitudinal direction of the structural component 200.

The structural component 200 is defined with a plurality of positioning grooves 200C. The positioning grooves 200C are spaced apart along the longitudinal direction of the structural component 200. The connection base 110 is provided with a positioning member 110B configured to engage in the positioning groove 200C to position the connection base 110.

In the embodiments, the connection base 110 of the quick-release assembly 100 is slidable relative to the structural component 200, thus the mounting position of the quick-release assembly on the structural component 200 can be adjusted. After moving to a predetermined position, the connection base 110 is positioned by engaging the positioning member 110B into the positioning groove 200C, and then the structural component 200 is clamped by the quick-release assembly 100, completing the connection. This helps to improve the positional accuracy of the quick-release assembly 100 on the structural component 200, and the connection stability between the quick-release assembly 100 and the structural component 200. In some embodiments, there are two positioning members 110B spaced apart along the sliding direction of the connection base 110 and located at opposite ends of the connection base 110. The connection base 110 is positioned by way of the engagement of the two positioning members 110B with two corresponding positioning grooves 200C among the plurality of positioning grooves 200C.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A quick-release assembly for a photographic accessory, the quick-release assembly comprising:
a connection base;
two clamping arms movably connected to the connection base, one clamping arm being arranged on a side of the connection base and the other clamping arm being arranged on an opposite side of the connection base, and the two clamping arms and the connection base cooperatively defining a mounting slot for mounting a structural component; and
a locking mechanism disposed on the connection base and configured to act on the two clamping arms;
wherein the quick-release assembly has a locked state and an unlocked state; wherein,
in the locked state, the two clamping arms are pressed by the locking mechanism, and the two clamping arms are closed toward each other and the structural component is clamped by the two clamping arms; and
in the unlocked state, the two clamping arms are released from the locking mechanism, and the two clamping arms are opened away from each other and the structural component is released from the two clamping arms.

2. The quick-release assembly of claim 1, wherein,
the two clamping arms are rotatably connected to the connection base, each of the two clamping arms comprises a clamping end configured to clamp the structural member and a pressure-receiving end; and
the locking mechanism comprises:
an operation component movably connected to the connection base, the operation component being configured to switch to a locking position to press against the pressure-receiving ends, to allow the two clamping arms to rotate so as to drive the clamping ends to clamp the structural component; and the operation component being further configured to switch to an unlocking position to release the pressure-receiving ends, to allow the two clamping arms to rotate so as to drive the clamping ends to release the structural component; and
a first elastic component, the first elastic component acting on the operation component, and being configured to provide an elastic force to the operation component to drive the operation component to return to the locking position.

3. The quick-release assembly of claim 2, wherein the operation component comprises:
a rotating member rotatably connected to the connection base;
a lever member connected to the rotating member or integrally formed with the rotating member, the lever member extending outward from a circumferential side of the rotating member, and the lever member being configured to drive the rotating member to rotate when subjected to an external force; and
a pressing member connected to the rotating member or integrally formed with the rotating member, the pressing member being configured to move along with rotation of the rotating member to press against or release the pressure-receiving ends.

4. The quick-release assembly of claim 3, wherein,
the connection base comprises a first half housing and a second half housing detachably connected to the first half housing, wherein the second half housing and the first half housing enclose an accommodation cavity;
the two clamping arms are rotatably connected to the first half housing, the pressure-receiving ends of the two clamping arms are located inside the accommodation cavity, and the clamping ends of the two clamping arms extend outside the accommodation cavity;
the rotating member is located inside the accommodation cavity and is rotatably connected to at least one selected from the group consisting of the first half housing and the second half housing;
the pressing member is located inside the accommodation cavity; and
at least one selected from the group consisting of the first half housing and the second half housing is defined with an avoidance opening, and the lever member extends through the avoidance opening to be exposed outside the connection base.

5. The quick-release assembly of claim 4, wherein,
the first half housing is defined with an accommodation groove extending around a rotation axis of the rotating member;
the operation component further comprises a connection member extending into the accommodation groove, wherein the connection member is arranged along a circumferential direction of the rotating member and configured to move along with the rotating member; and
the first elastic component comprises a spring received in the accommodation groove, an end of the spring is connected to a wall at an end of the accommodation groove, and the other end of the spring is connected to the connection member.

6. The quick-release assembly of claim 5, wherein,
the accommodation groove is one of two accommodation grooves, and the two accommodation grooves are arranged to face each other;
the spring is one of two springs, and each of the two springs is received in one of the two accommodation grooves; and
the connection member is one of two connection members, wherein one connection member is connected to the rotating member and extends into one accommodation groove to connect with the spring in the one accommodation groove, and the other connection member is connected to the lever member and extends into the other accommodation groove to connect with the spring in the other accommodation groove.

7. The quick-release assembly of claim 4, wherein,
the rotating member is defined with a shaft hole, a connecting shaft is provided on an inner wall of the second half housing, and the connecting shaft is inserted into the shaft hole to allow the rotating member to be rotatably connected to the second half housing; and
the connecting shaft is defined with a connection hole extending in an axial direction of the connecting shaft and penetrating through an outer wall of the second half housing.

8. The quick-release assembly of claim 4, wherein,
the rotating member is provided with a mounting hole and a limiting member, the mounting hole is located on a circumferential side of a rotation axis of the rotating member, the limiting member is slidably disposed in the mounting hole and is capable of elastically extending from or retracting into the mounting hole; and
the first half housing is defined with a limiting hole extending through the first half housing, a pushing member is slidably disposed in the limiting hole, and the pushing member is capable of extending from or retracting into an end opening of the limiting hole;
wherein the limiting hole is located along a rotation path of the limiting member, and the limiting member is capable of extending from the end opening of the limiting hole into the limiting hole to form a stopping and limiting on the rotating member; and the pushing member is capable of retracting into the limiting hole to push the limiting member out of the limiting hole, to cancel the stopping and limiting on the rotating member.

9. The quick-release assembly of claim 2, wherein,
each of the two clamping arms is provided with a first magnetic member disposed at the pressure-receiving end of the clamping arm; and
the connection base is provided with a second magnetic member disposed to face the first magnetic member, the second magnetic member is configured to apply a magnetic attraction force to the first magnetic member, wherein a direction of the magnetic attraction force is the same as a direction in which the operation component presses against the pressure-receiving end of the clamping arm.

10. A photographic accessory, comprising: an accessory body and the quick-release assembly of claim 1, wherein the connection base is connected to the accessory body.

11. The photographic accessory of claim 10, wherein,
the two clamping arms are rotatably connected to the connection base, each of the two clamping arms comprises a clamping end configured to clamp the structural member and a pressure-receiving end; and
the locking mechanism comprises:
an operation component movably connected to the connection base, the operation component being configured to switch to a locking position to press against the pressure-receiving ends, to allow the two clamping arms to rotate so as to drive the clamping ends to clamp the structural component; and the operation component being further configured to switch to an unlocking position to release the pressure-receiving ends, to allow the two clamping arms to rotate so as to drive the clamping ends to release the structural component; and
a first elastic component, the first elastic component acting on the operation component, and being configured to provide an elastic force to the operation component to drive the operation component to return to the locking position.

12. The photographic accessory of claim 11, wherein the operation component comprises:
a rotating member rotatably connected to the connection base;
a lever member connected to the rotating member or integrally formed with the rotating member, the lever member extending outward from a circumferential side of the rotating member, and the lever member being configured to drive the rotating member to rotate when subjected to an external force; and
a pressing member connected to the rotating member or integrally formed with the rotating member, the pressing member being configured to move along with rotation of the rotating member to press against or release the pressure-receiving ends.

13. The photographic accessory of claim 12, wherein,
the connection base comprises a first half housing and a second half housing detachably connected to the first half housing, wherein the second half housing and the first half housing enclose an accommodation cavity;
the two clamping arms are rotatably connected to the first half housing, the pressure-receiving ends of the two clamping arms are located inside the accommodation cavity, and the clamping ends of the two clamping arms extend outside the accommodation cavity;
the rotating member is located inside the accommodation cavity and is rotatably connected to at least one selected from the group consisting of the first half housing and the second half housing;
the pressing member is located inside the accommodation cavity; and
at least one selected from the group consisting of the first half housing and the second half housing is defined with an avoidance opening, and the lever member extends through the avoidance opening to be exposed outside the connection base.

14. The photographic accessory of claim 13, wherein,
the first half housing is defined with an accommodation groove extending around a rotation axis of the rotating member;
the operation component further comprises a connection member extending into the accommodation groove, wherein the connection member is arranged along a circumferential direction of the rotating member and configured to move along with the rotating member; and
the first elastic component comprises a spring received in the accommodation groove, an end of the spring is connected to a wall at an end of the accommodation groove, and the other end of the spring is connected to the connection member.

15. The photographic accessory of claim 14, wherein,
the accommodation groove is one of two accommodation grooves, and the two accommodation grooves are arranged to face each other;
the spring is one of two springs, and each of the two springs is received in one of the two accommodation grooves; and
the connection member is one of two connection members, wherein one connection member is connected to the rotating member and extends into one accommodation groove to connect with the spring in the one accommodation groove, and the other connection member is connected to the lever member and extends into the other accommodation groove to connect with the spring in the other accommodation groove.

16. The photographic accessory of claim 13, wherein,
the rotating member is defined with a shaft hole, a connecting shaft is provided on an inner wall of the second half housing, and the connecting shaft is inserted into the shaft hole to allow the rotating member to be rotatably connected to the second half housing; and
the connecting shaft is defined with a connection hole extending in an axial direction of the connecting shaft and penetrating through an outer wall of the second half housing.

17. The photographic accessory of claim 13, wherein,
the rotating member is provided with a mounting hole and a limiting member, the mounting hole is located on a circumferential side of a rotation axis of the rotating member, the limiting member is slidably disposed in the mounting hole and is capable of elastically extending from or retracting into the mounting hole; and
the first half housing is defined with a limiting hole extending through the first half housing, a pushing member is slidably disposed in the limiting hole, and the pushing member is capable of extending from or retracting into an end opening of the limiting hole;
wherein the limiting hole is located along a rotation path of the limiting member, and the limiting member is capable of extending from the end opening of the limiting hole into the limiting hole to form a stopping and limiting on the rotating member; and the pushing member is capable of retracting into the limiting hole to push the limiting member out of the limiting hole, to cancel the stopping and limiting on the rotating member.

18. The photographic accessory of claim 11, wherein,
each of the two clamping arms is provided with a first magnetic member disposed at the pressure-receiving end of the clamping arm; and
the connection base is provided with a second magnetic member disposed to face the first magnetic member, the second magnetic member is configured to apply a magnetic attraction force to the first magnetic member, wherein a direction of the magnetic attraction force is the same as a direction in which the operation component presses against the pressure-receiving end of the clamping arm.

19. An assembly and disassembly kit, comprising: a structural component and the photographic accessory of claim 10, wherein the structural component is connected to the quick-release assembly.

20. The assembly and disassembly kit of claim 19, wherein,
the connection base is slidable relative to the structural component along a longitudinal direction of the structural component; and
the structural component is defined with a plurality of positioning grooves spaced apart along the longitudinal direction of the structural component, the connection base is provided with a positioning member, and the positioning member is configured to engage with at least one of the plurality of positioning grooves to position the connection base.
